(19) United States
(12) Patent Application Publication
(10) Pub. No.: US 2015/0205232 A1
(43) Pub. Date: Jul. 23, 2015

(54) SYSTEMS AND METHODS FOR PROVIDING AND IMPLEMENTING LOW SURFACE ENERGY EXTERNAL HEAT ROLLS IN IMAGE FORMING DEVICES

(71) Applicant: XEROX CORPORATION, Norwalk, CT (US)

(72) Inventors: Robert W. PHELPS, Victor, NY (US); Paul M. FROMM, Rochester, NY (US); Steven M. RUSSEL, Bloomfield, NY (US); Erwin RUIZ, Rochester, NY (US)

(73) Assignee: XEROX CORPORATION, Norwalk, CT (US)

(21) Appl. No.: 14/161,680

(22) Filed: Jan. 22, 2014

(51) Int. Cl. G03G 15/20

(52) U.S. Cl. CPC G03G 15/206

(57) ABSTRACT

A system and method are provided for methods for reducing the adverse effects attributable to excess toner contamination in image forming devices through providing and implementing low surface energy surfaces on individual rolls, including external heat rolls in the image forming devices. The disclosed external heat rolls are configured of materials that introduce a more robust low surface energy component into the materials that compose at least a rough external heat roll material for the external heat rolls.

### BACKGROUND

1. Field of the Disclosed Embodiments

This disclosure relates to systems and methods for reducing the adverse effects attributable to excess toner contamination in image forming devices through providing and implementing configurations for contact surfaces on individual rolls, including external heat rolls in the image forming devices, the contact surfaces being formed of robust materials and configured in such a manner to reduce average surface energies.

2. Related Art

Many modern image forming devices have internal processing components that are composed of one or more heated roll elements, or heat rolls. Principally, such heated roll elements are included as heated fuser rolls, and/or associated heated rolls for transferring heat to a surface of a fuser roll, in one or more toner fusing and fixing modules. These heated roll elements are formed of materials that demonstrate progressively increasing thermal conductivity over conventional, e.g., VITON® surfaced, heat rolls. The increased thermal conductivity on and through the surfaces of the heated fuser-system rolls may be provided through an implementation of carbon nanotube technology (CNT). An advantage of the increased surface thermal conductivity enables fusing at higher speeds for increased productivity in the image forming devices in which the advanced rolls are employed.

The advantages of implementing the heated roll elements, or heat rolls, with increased thermal conductivity are offset somewhat by what has emerged as an observed disadvantage or dysfunction to their use. This disadvantage or dysfunction, particularly associated with the interaction of higher thermal conductivity CNT heated fuser rolls and cooperating conductive pressure rolls (CPRs) at the fusing nip, is an increase in a toner dirt contamination rate from excess toner contamination.

The increase in toner dirt contamination rate is attributable to the interaction between the CNT and CPR rolls, and stress paper conditions as a function of, for example, rough (uncoated) image receiving media surface finishes and image types (half tone images). Collected experimental data reveals that the rougher the image receiving media substrate surfaces, the more the toner dirt contamination is generated. In general, excess toner contamination is created by unfused toner particles in half tone images on uncoated/rough media.

### SUMMARY OF DISCLOSED EMBODIMENTS

In a typical advanced fuser module 100 for use in a modern image forming system such as that shown, for example, in FIG. 1, a plurality of roll elements are used, in combination, to fix and finish images consisting of a combination of unfused toner elements 160 deposited on image receiving media substrates that are transported to the fuser module 100 from a marking module (not shown) on an image receiving media substrate transport 150. A fusing nip is formed between the CPR 135 and the increased thermal conductivity CNT heated fuser roll 130 to fuse and fix the image 165 on the substrate.

An oiler unit 140 may be typically provided to condition a surface of the increased thermal conductivity CNT heated fuser roll 130 to promote highest efficiency fusing in a manner that attempts to substantially limit back transfer of unfused toner material particles 180 to the increased thermal conductivity CNT heated fuser toll 130. Back transfer is a phenomenon in which, based on subtle differences in adherence properties, a certain, even small, percentage of toner adheres to the heated surfaces rather than to the image receiving media substrate emerging from the fuser nip in the fusing and fixing process. These unfused toner particles adversely affect image quality of subsequent images processed at the fuser nip. The oiler unit 140 may typically include, for example, a metering roll 142, an oil reservoir 144 and a donor roll 146 that combine to provide a renewable surface conditioning coating on a surface of the increased thermal conductivity CNT heated fuser roll 130 to reduce the proclivity of the surface to adherence.

Regardless of the attempts at mitigation to date, a portion of the unfused toner elements 160 continue to separate as unfused toner material particles 180 and travel over a surface of the increased thermal conductivity CNT heated fuser roll 130 and a first external heat roll 120 and a second external heat roll 125. The external heat rolls 120,125 may be heated internally with one or more internal heating elements 127, or one or more external heating elements 122, or combinations thereof

In certain image forming systems, additional processing elements are added to further mitigate the adverse effects of adhered unfused toner particle contamination, including use of a web cleaner system 110. The web cleaner system 110 may typically consist of a web supply roll 112, a web contact roll 114, and a web take-up roll 116 about which a web cleaning material 118 is disposed in a manner that allows for collection of the unfused toner material particles 180.

As processing speeds increase, particularly in image forming operations that are conducted against certain high stress conditions, the excess toner contamination will ultimately over saturate the web cleaning material 118 in a typical web cleaner system 110, thereby adversely affecting an ability of the web cleaner system 110 to effectively pick up the loose unfused toner material particles 180 from the surfaces of the first external heat roll 120 and the second external heat roll 125. Once any of the components of the fuser module 100 become over saturated with unfused toner material particles 180, the unfused toner material particles 180 will remain on, or will be redeposited on, surfaces of the second external heat roll 125, the fuser roll 130 and the first external heat roll 120. The excess toner contamination will eventually re-manifest itself in creating image defects that the mitigation efforts were intended to address. An additional adverse effect of the excess toner contamination, in addition to the image defects that are not addressed, is the potential for inducing premature fuser roll failure. Other adverse effects may include reduction in external heat roll cleaning intervals, and increases in occurrences of toner chunks in the system due to web material over saturation. The accumulated and uncleaned toner chunks may also fall on a surface of the image receiving media substrate upstream of the fusing nip in a process direction leading to the image defects.

Current methodologies, techniques and/or schemes for mitigating or countering these issues generally involve increasing a speed of the web cleaner system 110 in attempts to maintain an effective cleaning rate for stress media. The difficulty is that this “solution” has its own inherent drawback of adversely affecting run cost for image production in the image forming device of which the fuser module 100 is a part. Simply increasing the web speed alone may prove ineffective in providing the necessary cleaning latitude to support increasing image forming capacity available with the use of increasingly thermally conductive fuser rolls rendering this workaround, at best, a partial or limited solution to the difficulties arising from excess toner contamination. Further, it should be recognized that, to be more effective, the conventional methodologies may require an increase in a number of manual cleaner cycles and/or servicings for a particular image forming device. These manual cleaner cycles and/or servicings may involve stopping production in the involved image forming devices. Those skilled in the art recognize that each such stoppage for service may involve not only the time for the cleaning operation itself, but otherwise extended periods of inactivity for the heated components to cool before being serviced.

In view of the above shortfalls in conventional solutions, it would be advantageous to provide systems, methods, techniques, schemes and/or processes that may include particularly-configured heat rolls to aid in further mitigating the adverse effects of the excess toner contamination, particularly in fuser modules, in image forming devices.

Exemplary embodiments of the systems and methods according to this disclosure may provide particularly configured structures that are intended to mitigate the potential for toner over saturation leading to the adverse effects associated with excess toner contamination in image forming devices.

Exemplary embodiments may provide robust low surface energy external heat rolls that exhibit significantly less toner contamination than the more conventional smooth external heat rolls with a CNT-CPR roll pair configuration.

Previous efforts directed at reducing surface energy on external heat rolls included coating the surfaces of the heat rolls with Perfluoroalkoxy or PFA, a type of fluoropolymer with properties similar to polytetrafluoroethylene or PTFE. PFA differs from the PTFE resins in that PFA is a melt-processable Teflon®-type coating that is usable in injection molding and/or screw extrusion techniques. PFA is known to have a low coefficient of friction. However, PFA surfaces are not robust, are easily scratched and have been proven, in these systems, to be difficult to clean once contaminated, thereby leading to limited life cycles for these components.

Exemplary embodiments may introduce a more robust configuration for components of a contact surface intermingled with a low surface energy component material that cooperate to produce at least a rough external heat roll surface with a reduced average surface energy.

Exemplary embodiments may incorporate a roughened anodized surface for an external heat roll component in which valleys or interstices in the roughened anodized surface may be partially filled or otherwise lined with a material exhibiting a low surface energy in order that an average surface energy across the entirety of the contact surface of the heat roll component may be reduced.

These and other features, and advantages, of the disclosed systems and methods are described in, or apparent from, the following detailed description of various exemplary embodiments.

### BRIEF DESCRIPTION OF THE DRAWINGS

Various exemplary embodiments of the disclosed systems and methods for reducing excess toner contamination in image forming devices through providing and implementing configurations for contact surfaces on individual rolls, including external heat rolls in the image forming devices, the contact surfaces being formed of robust materials having reduced average surface energies, will be described, in detail, with reference to the following drawings, in which:

FIG. 1 illustrates an example of a conventional fuser module and the excess toner contamination phenomenon that may be addressed by the systems and methods according to this disclosure;

FIG. 2 illustrates a conventional external heat roll having a low surface energy coating on its contact surface which may be improved by implementing the improved configurations and/or improved materials implementations according to this disclosure;

FIG. 3 illustrates an exemplary embodiment of a particularly-configured external heat roll including a robust lower average surface energy contact surface according to this disclosure;

FIG. 4 illustrates a more detailed view of an exemplary configuration for the contact surface of the particularly-configured external heat roll shown in FIG. 3 according to this disclosure;

FIG. 5 illustrates a block diagram of an exemplary system for operating an image forming device with one or more particularly-configured external heat rolls according to this disclosure; and

FIG. 6 illustrates a flowchart of an exemplary method for operating an image forming device with one or more particularly-configured external heat rolls according to this disclosure.

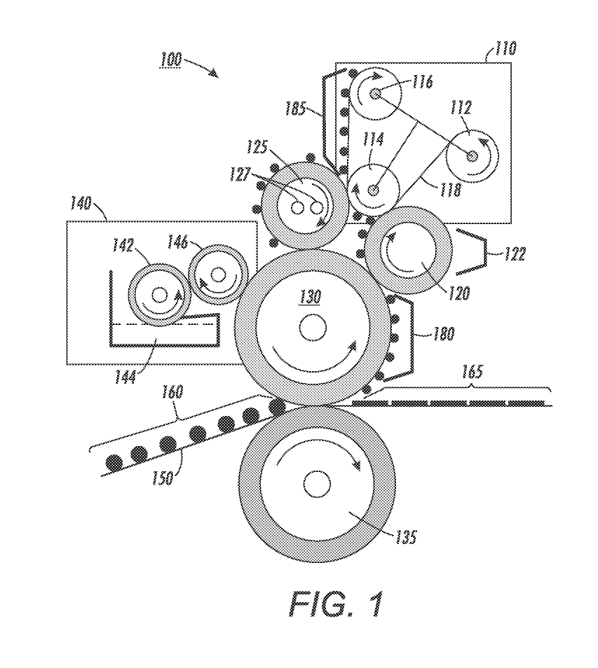

### DETAILED DESCRIPTION OF THE DISCLOSED EMBODIMENTS

The systems and methods for reducing excess toner contamination in image forming devices through providing and implementing contact surfaces on individual rolls, including external heat rolls in the image forming devices, the contact surfaces being configured and/or formed of robust materials interspersed with additional material components to reduce average surface energies according to this disclosure will generally refer to this specific utility for those systems and methods. Exemplary embodiments described and depicted in this disclosure should not be interpreted (1) as being specifically limited to any particular configuration of an image forming device, or any individual module, including a fuser module, housed within, or otherwise associated with, an image forming device, or (2) as being directed to any particular limiting intended use. In fact, any excess toner contamination remediation system, component or technique that may benefit from the systems and methods of implementing robust contact surfaces having comparatively reduced surface energies according to this disclosure is contemplated.

Specific reference to, for example, any particular image forming device, including but not limited to any of a printer, copier, scanner, facsimile machine or multi-function device, should be understood as being exemplary only, and not limited, in any manner, to any particular class of such devices. The systems and methods according to this disclosure will be described as being particularly adaptable to use in printing and/or copying devices that produce output images according to input data and instructions that may be transmitted to a particular printing and/or copying device, but should not be considered as being limited to only these types of devices. Any commonly known image forming device, particularly one that employs toner particles, as that term is commonly understood to those of skill in the art, as the marking material or medium for producing images on an image receiving media substrate, which may be adapted according to the specific capabilities discussed in this disclosure, is contemplated.

The disclosed embodiments may be advantageously configured and operated using particularly formed external heat rolls that are formed of robust surface substances, at least in a surface layer, but that are configured in a manner to result in a comparatively low surface energy for the external heat rolls. Such a configuration is intended to aid in reducing the occurrences and adverse effects of excess toner contamination in the fuser modules of image forming devices.

Table 1 below provides an exemplary list of solid surface energy information for a broad array of common polymers. Conventionally, VITON® is employed as the outer coating on certain heated roll devices. VITON® has certain properties that make it usable, in fact, preferable for certain heated roll applications. Heated rolls with contact surfaces coated in VITON® appropriately conduct heat while molding themselves to cooperating heated roll components to, for example, extend a nip length. VITON® is understood by those of skill in the art to have a surface free energy (at 20° C.) in a range of approximately 31.5 mN/m. An objective of the systems and methods according to this disclosure is to find a combination of product materials, and/or a configuration for the surface layer for a heat roll, that will produce an average surface energy in a range of approximating Teflon® (approximately 20 mN/m at 20° C.) while maintaining a robustness that is not enjoyed by Teflon®-coated appliances, thereby avoiding a need to replace the appropriately-configured heated roll components more often than necessary or prescribed.

TABLE 1
Solid Surface Energy Data (SFE) For Common Polymers

| | Chemical | Surface | | Dispersive | Polar |
|---|---|---|---|---|---|
| | Abstracts | free | Temperature | contribution | contribution |
| | Service (CAS) | energy | Coefficient SFE | of SFE in | of SFE in |
| | Reference | (SFE) at 20° C. | in mN/(mK) | mN/m | mN/m |
| Name [symbol] | Number [symbol] | in mN [symbol] | [symbol] | [symbol] | [symbol] |
| Polyethylene-linear PE | 9002-88-4 | 35.7 | −0.057 | 35.7 | 0 |
| Polyethylene-branched PE | 9002-88-4 | 35.3 | −0.067 | 35.3 | 0 |
| Polypropylene-isotactic PP | 25085-53-4 | 30.1 | −0.058 | 30.1 | 0 |
| Polyisobutylene PIB | 9003-27-4 | 33.6 | −0.064 | 33.6 | 0 |
| Polystyrene PS | 9003-53-6 | 40.7 | −0.072 | −34.5 | −6.1 |
| Poly-α-methyl styrene PMS | 9017-21-4 | 39 | −0.058 | −35 | −4 |
| (Polyvinyltoluene PVT) | | | | | |
| Polyvinyl fluoride PVF | 24981-14-4 | 36.7 | — | −31.2 | −5.5 |
| Polyvinylidene fluoride PVDF | 24937-79-9 | 30.3 | — | −23.3 | −7 |
| Polytrifluoroethylene | 24980-67-4 | 23.9 | — | 19.8 | 4.1 |
| P3FEt/PTrFE | | | | | |
| Polytetrafluoroethylene PTFE | 9002-84-0 | 20 | −0.058 | 18.4 | 1.6 |
| (Teflon ™) | | | | | |
| Polyvinylchloride PVC | 9002-86-2 | 41.5 | — | −39.5 | −2 |
| Polyvinylidene chloride PVDC | 9002-85-1 | 45 | — | −40.5 | −4.5 |
| Polychlorotrifluoroethylene | 25101-45-5 | 30.9 | −0.067 | 22.3 | 8.6 |
| PCTrFE | | | | | |
| Polyvinylacetate PVA | 9003-20-7 | 36.5 | −0.066 | 25.1 | 11.4 |
| Polymethylacrylate | 25087-26-7 | 41 | −0.077 | 29.7 | 10.3 |
| (Polymethacrylic acid) PMAA | | | | | |
| Polyethylacrylate PEA | 9003-32-1 | 37 | −0.077 | 30.7 | 6.3 |
| Polymethylmethacrylate PMMA | 87210-32-0 | 41.1 | −0.076 | 29.6 | 11.5 |
| Polyethylmethacrylate PEMA | 9003-42-3 | 35.9 | −0.07 | 26.9 | 9 |
| Polybutylmethacrylate PBMA | 25608-33-7 | 31.2 | −0.059 | 26.2 | 5 |
| Polyisobutylmethacrylate PIBMA | 9011-15-8 | 30.9 | −0.06 | 26.6 | 4.3 |
| Poly(t-butylmethacrylate) PtBMA | — | 30.4 | −0.059 | 26.7 | 3.7 |
| Polyhexylmethacrylate PHMA | 25087-17-6 | 30 | −0.062 | −27 | −3 |
| Polyethyleneoxide PEO | 25322-68-3 | 42.9 | −0.076 | 30.9 | 12 |
| Polytetramethylene oxide PTME | 25190-06-1 | 31.9 | −0.061 | 27.4 | 4.5 |
| (Polytetrahydrofurane PTHF) | | | | | |
| Polyethyleneterephthalate PET | 25038-59-9 | 44.6 | −0.065 | −35.6 | −9 |
| Polyamide-6,6 PA-66 | 32131-17-2 | 46.5 | −0.065 | −32.5 | −14 |
| Polyamide-12 PA-12 | 24937-16-4 | 40.7 | — | 35.9 | 4.9 |
| Polydimethylsiloxane PDMS | 9016-00-6 | 19.8 | −0.048 | 19 | 0.8 |
| Polycarbonate PC | 24936-68-3 | 34.2 | −0.04 | 27.7 | 6.5 |
| Polyetheretherketone PEEK | 31694-16-13 | 42.1 | — | 36.2 | 5.9 |

As will be described in greater detail below, with the aid of the guidance provided by the materials factors shown in Table 1, combinations of materials can be selected to reduce an average surface energy of a contact surface of a heat roll well below the level of VITON® to something approximating Teflon®.

As shown in FIG. 4, a third exemplary embodiment 400 of a particularly configured external heat roll may be formed throughout, as a substantially integral structure 410, of a robust material that imparts a low surface energy to the outer surface of the heat roll.

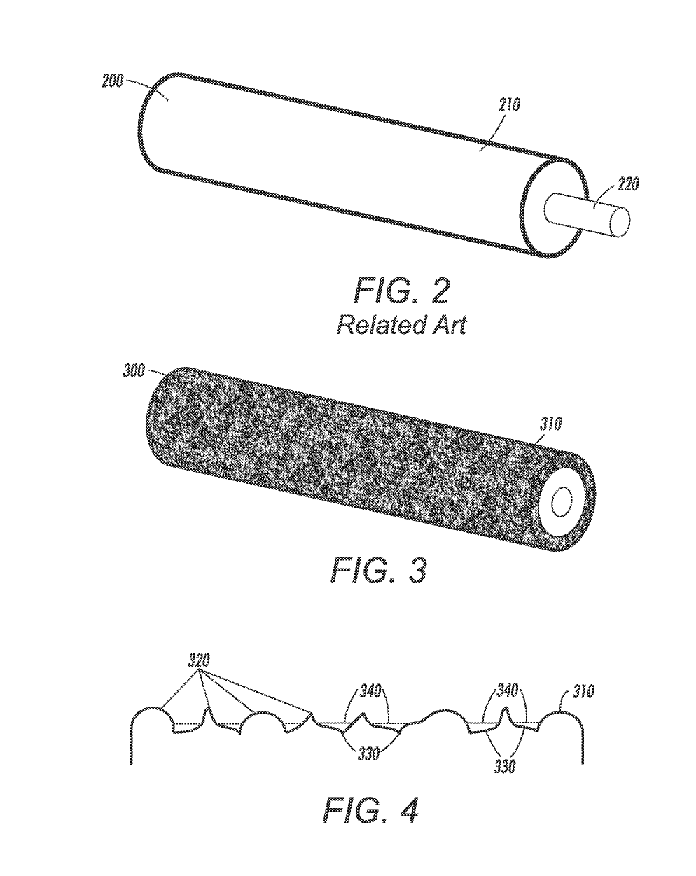

FIG. 2 illustrates a conventional external heat roll 200 having a low surface energy coating 210 on its contact surface which may be improved upon by implementing the improved configurations and/or improved materials implementations according to this disclosure. As shown in FIG. 2, the heat roll, in any of the illustrated exemplary configurations may be rotatable about a longitudinal spindle 220.

FIG. 3 illustrates an exemplary embodiment of a particularly configured external heat roll 300 including a robust low surface energy contact surface 310 according to this disclosure. The particularly-configured external heat roll 300 may be formed with an outer layer 310 of a multi-layer structure, the outer layer 310 being formed at least in part, for example, with an anodized coarse surface of a robust material that is interspersed in valleys, pits or interstices with a material of comparatively lower surface energy in a manner that reduces an average surface energy of the entirety of the outer surface of the heat roll.

FIG. 4 illustrates a more detailed view of an exemplary configuration for the contact surface 310 of the particularly configured external heat roll shown in FIG. 3. As shown in FIG. 4, the contact surface 310 may be comprised of a roughened, or micro-roughened, surface of a robust or anodized material, in which the peaks 320 may present a comparatively wear-resistant surface when presented for contact with other roller elements, including heated fuser roll elements and/or roll surface cleaning elements. The valleys, pits or interstices 330 between the peaks may be lined partially or fully with a material 340 that has a comparatively low surface energy (see Table 1 above). An objective of the depicted and otherwise disclosed configurations for the contact surfaces of the heat rolls is to, for example, combine robust materials for wear resistant contact with low surface energy materials to promote surface cleaning in support of reducing toner contamination without adversely affecting image forming operations in the image forming devices in which such particularly-configured heat rolls are deployed.

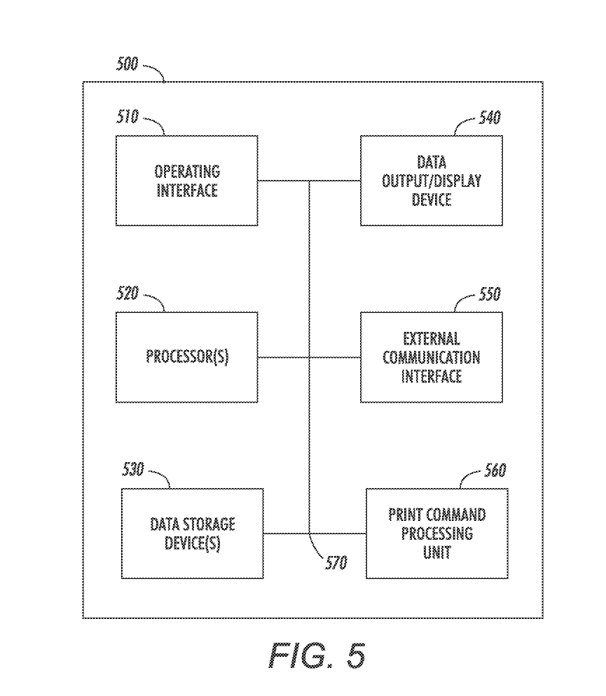

FIG. 5 illustrates a block diagram of an exemplary system 500 for operating an image forming device with one or more external heat rolls according to this disclosure. Components of the exemplary system 500 shown in FIG. 5 may be, for example, housed in a user workstation, in a server or in an image forming device.

The exemplary system 500 may include an operating interface 510 by which a user may communicate with the exemplary system 500, or otherwise by which the exemplary system 500 may receive instructions input to it from another source. In instances where the operating interface 510 may be a locally accessible user interface, the operating interface 510 may be configured as one or more conventional mechanisms common to computing and/or image forming devices that permit a user to input information to the exemplary system 500. The operating interface 510 may include, for example, a conventional keyboard and mouse, a touchscreen with “soft” buttons or with various components for use with a compatible stylus, a microphone by which a user may provide oral commands to the exemplary system 500 to be “translated” by a voice recognition program, or other like device by which a user may communicate specific operating instructions to the exemplary system 500.

The exemplary system 500 may include one or more local processors 520 for individually operating the exemplary system 500 and for carrying out processing, assessment, reporting and control functions. Processor(s) 520 may include at least one conventional processor or microprocessor that interprets and executes instructions to direct specific operation and analysis functions with regard to image data that is commanded or intended to direct image forming in a specific image forming device with which the exemplary system 500 is associated.

The exemplary system 500 may include one or more data storage devices 530. Such data storage device(s) 530 may be used to store data or operating programs to be used by the exemplary system 500, and specifically the processor(s) 520, in carrying out the image forming control functions of the exemplary system 500. Data storage device(s) 530 may be used to collect information regarding any or all of the functions of the exemplary system 500. The data storage device(s) 530 may include a random access memory (RAM) or another type of dynamic storage device that is capable of storing collected information, and separately storing instructions for execution of system operations by, for example, processor(s) 520. Data storage device(s) 530 may also include a read-only memory (ROM), which may include a conventional ROM device or another type of static storage device that stores static information and instructions for processor(s) 520. Further, the data storage device(s) 530 may be integral to the exemplary system 500, or may be provided external to, and in wired or wireless communication with, the exemplary system 500.

The exemplary system 500 may include at least one data output/display device 540, which may be configured as one or more conventional mechanisms that output information to a user, including a display screen on a computing or image forming device, including a graphical user interface (GUI) on the image forming device. The data output/display device 540 may be usable to display to a user an indication of image forming data, and a selection of image receiving media, that may be evaluated to indicate a control function to mitigate adverse effects of excess toner contamination associated with a particular image forming operation in an image forming device. The data output/display device 340 may then be usable, in conjunction with the operating interface 310 to display to a user a series of options for optimized image forming operations in the image forming device.

The exemplary system 500 may include one or more separate external communication interfaces 550 by which the exemplary system 500 may communicate with components external to the exemplary system 500, or by which the exemplary system 500 may communicate with an image forming device with which the exemplary system 500 may be associated when it is not fully integral to the image forming device. No particular limiting configuration to the external communication interface(s) 550 is to be implied by the depiction in FIG. 5, other than that the external communication interface(s) 550 may be configured to connect to external components via one or more available wired or wireless communication links.

The exemplary system 500 may include a print command processing unit 560, which may be a part or a function of processor 520 coupled to, for example, one or more storage devices 530, or may be a separate stand-alone component module or circuit in the exemplary system 500. The print command processing unit 560 may review control and image data that specify an image forming operation to be carried out by the image forming device. The print command processing unit 560 may then control the image forming operation in the image forming device according to the control and image data, and particularly control heat levels in one or more heated roll components in the image forming device.

All of the various components of the exemplary system 500, as depicted in FIG. 5, may be connected by one or more data/control busses 570. These data/control busses 570 may provide wired or wireless communication between the various components of the exemplary system 500, whether all of those components are housed integrally in, or are otherwise external and connected to, the exemplary system 500.

It should be appreciated that, although depicted in FIG. 5 as what appears to be an integral unit, the various disclosed elements of the exemplary system 500 may be arranged in any combination of sub-systems as individual components or combinations of components, integral to a single unit, or external to, and in wired or wireless communication with the single unit of the exemplary system 500. In other words, no specific configuration as an integral unit or as a support unit is to be implied by the depiction in FIG. 5. Further, although depicted as individual units for ease of understanding of the details provided in this disclosure regarding the exemplary system 500, it should be understood that the described functions of any of the individually-depicted components may be undertaken, for example, by one or more processors 520 connected to, and in communication with, one or more data storage devices 530.

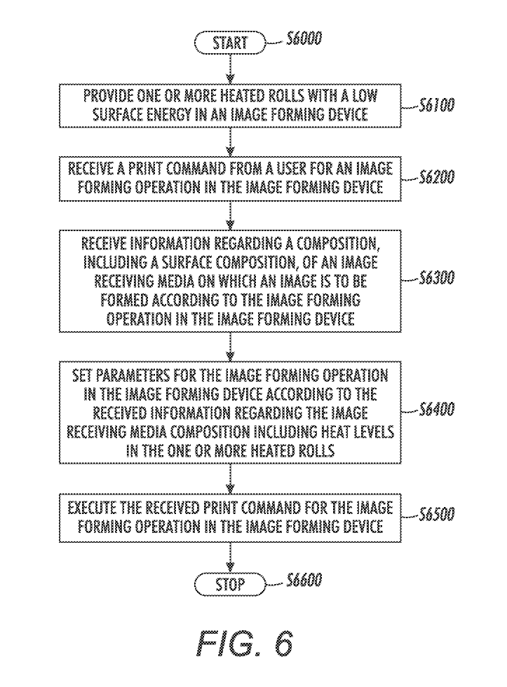

The disclosed embodiments may include an exemplary method for operating an image forming device with one or more external heat rolls. FIG. 6 illustrates a flowchart of such an exemplary method. As shown in FIG. 6, operation of the method commences at Step S6000 and proceeds to Step S6100.

In Step S6100, one or more heat rolls that are formed and/or otherwise configured to have a comparatively low average surface energy may be provided in an image forming device. Operation of the method proceeds to Step S6200.

In Step S6200, a print command for an image forming operation in the image forming device may be received from a user. Operation of the method proceeds to Step S6300.

In Step S6300, information may be received regarding a composition, including a surface composition, of an image receiving media substrate on which an image is to be formed according to the image forming operation in the image forming device. Operation of the method proceeds to Step S6400.

In Step S6400, parameters may be set in the image forming device for the image forming operation. The parameters may include heat levels to be set in the one or more heat rolls. Operation of the method proceeds to Step S6500.

In Step S6500, the received print command may be executed in the image forming device. Operation of the method proceeds to Step S6600, where operation of the method ceases.

The disclosed embodiments may include a non-transitory computer-readable medium storing instructions which, when executed by a processor, may cause the processor to execute all, or at least some, of the steps of the method outlined above.

The above-described exemplary systems and methods reference certain conventional components to provide a brief, general description of suitable print processing environments in which the subject matter of this disclosure may be implemented for familiarity and ease of understanding. Although not required, embodiments of the disclosure may be provided, at least in part, in a form of hardware circuits, firmware, or software computer-executable instructions to carry out the specific functions described. These may include individual program modules executed by a processor. Generally, program modules include routine programs, objects, components, data structures, and the like that perform particular tasks or implement particular data types in support of the overall objective of the systems and methods according to this disclosure.

Those skilled in the art will appreciate that other embodiments of the disclosed subject matter may be practiced in widely varying image forming environments with many types of image forming devices.

As indicated above, embodiments within the scope of this disclosure may also include computer-readable media having stored computer-executable instructions or data structures that can be accessed, read and executed by one or more processors. Such computer-readable media can be any available media that can be accessed by a processor, general purpose or special purpose computer. By way of example, and not limitation, such computer-readable media can comprise RAM, ROM, EEPROM, CD-ROM, flash drives, data memory cards or other analog or digital data storage device that can be used to carry or store desired program elements or steps in the form of accessible computer-executable instructions or data structures. When information is transferred or provided over a network or another communications connection, whether wired, wireless, or in some combination of the two, the receiving processor properly views the connection as a computer-readable medium. Thus, any such connection is properly termed a computer-readable medium. Combinations of the above should also be included within the scope of the computer-readable media for the purposes of this disclosure.

Computer-executable instructions include, for example, non-transitory instructions and data that can be executed and accessed respectively to cause a processor to perform certain of the above-specified functions, individually or in various combinations. Computer-executable instructions may also include program modules that are remotely stored for access and execution by a processor.

The exemplary depicted sequence of executable instructions or associated data structures represents one example of a corresponding sequence of acts for implementing the functions described in the steps. The exemplary depicted steps may be executed in any reasonable order to effect the objectives of the disclosed embodiments. No particular order to the disclosed steps of the method is necessarily implied by the depiction in FIG. 6, nor do all of the steps need to be performed, except where a particular method step is a necessary precondition to execution of any other method step.

Although the above description may contain specific details, they should not be construed as limiting the claims in any way. Other configurations of the described embodiments of the disclosed systems and methods are part of the scope of this disclosure.

It will be appreciated that various of the above-disclosed and other features and functions, or alternatives thereof, may be desirably combined into many other different systems or applications. Also, various alternatives, modifications, variations or improvements therein may be subsequently made by those skilled in the art which are also intended to be encompassed by the following claims.

1. A heatable roll component for use in an image forming device, comprising:
a heated roll body formed at least in part of a material having a high thermal conductivity and configured to be rotatable around a center longitudinal axis; and
a low surface energy surface on an outer surface of the heated roll body, the low surface energy surface comprising:
a coarse surface component formed of an anodized material that presents contact peaks and associated valleys; and
a low surface energy material component that only partially fills or lines the associated valleys,
an average surface energy of the low surface energy surface being in a range of 25 mN/m or less.

2. The heatable roll component of claim 1, the low surface energy surface being an outer surface layer coating over a longitudinal surface of the heated roll body.

3. The heatable roll component of claim 1, the heated roll body having a multi-layer construction consisting of two layers of substantially a same thickness, the two layers comprising:
an inner layer formed of a high thermal conductivity material; and
an outer layer comprising the low surface energy surface.

4-8. (canceled)

9. A fusing unit in an image forming device, comprising:
a heatable fusing surface component;
a pressure applying component that cooperates with the heatable fusing surface component to form a fusing nip for fusing marking material on an image receiving media substrate; and
at least one external heat roll that is provided and positioned such that an external surface of the heat roll contacts an external surface of the heatable fusing surface component,
the at least one external heat roll having:
a heated roll body formed at least in part of a material having a high thermal conductivity and configured to be rotatable around a center longitudinal axis; and
a low surface energy surface on an outer surface of the heated roll body, the low surface energy surface comprising:
a coarse surface component formed of an anodized material that presents contact peaks and associated valleys; and
a low surface energy material component that only partially fills or lines the associated valleys,
an average surface energy of the low surface energy surface being in a range of 25 mN/m or less.

10. The fusing unit of claim 9, further comprising a web cleaning system configured to provide a cleaning web in contact with the at least one external heat roll to clean a surface of the at least one external heat roll.

11. The fusing unit of claim 9, further comprising an oiler unit for conditioning the external surface of the heatable fusing surface component.

12. The fusing unit of claim 9, the low surface energy surface being an outer surface layer coating over a longitudinal surface of the heated roll body.

13. The fusing unit of claim 9, the heated roll body having a multi-layer construction consisting of two layers of substantially a same thickness, the two layers comprising:
an inner layer formed of a high thermal conductivity material; and
an outer layer comprising the low surface energy surface.

14. The fusing unit of claim 9, the heated roll body being heated by at least one internal heating component.

15. The fusing unit of claim 9, the heated roll body being heated by at least one external heating component.

16-20. (canceled)
